(19) United States
(12) Patent Application Publication
(10) Pub. No.: US 2026/0145577 A1
(43) Pub. Date: May 28, 2026

(54) Device and Method for Controlling Battery Output, and Eco-Friendly Vehicle Including Same

(71) Applicants: Hyundai Motor Company, Seoul (KR); Kia Corporation, Seoul (KR)

(72) Inventors: Cheol Ho Jang, Hwaseong-Si (KR); Yoon Jun Lee, Hwaseong-Si (KR); Min Hyung Sim, Hwaseong-Si (KR); Dong Il Kim, Hwaseong-Si (KR); Hyeon Ju Jeong, Hwaseong-Si (KR)

(21) Appl. No.: 19/226,599

(22) Filed: Jun. 3, 2025

(30) Foreign Application Priority Data
Nov. 27, 2024 (KR) 10-2024-0172611

(51) Int. Cl. B60L 58/14

(52) U.S. Cl. CPC B60L 58/14

(57) ABSTRACT

An apparatus of a vehicle may comprise a processor and a memory storing at least one instruction configured, when executed by the processor communicating with the memory, to cause the apparatus to determine, based on a monitored output value of a battery of the vehicle exceeding an allowable output value of the battery, a new output limit value of the battery for reducing a difference between the monitored output value of the battery and a preset initial output limit value of the battery. The apparatus may change the preset initial output limit value to the new output limit value such that an output of the battery is controlled by the new output limit value. The apparatus may perform, based on the output of the battery being controlled by the new output limit value, at least one operation of the vehicle.

### CROSS-REFERENCE TO THE RELATED APPLICATION

The present application claims the benefit of priority under 35 U.S.C. 119 to Korean Patent Application No. 10-2024-0172611, filed on Nov. 27, 2024, in the Korean Intellectual Property Office, the disclosure of which is incorporated herein by reference in its entirety.

### TECHNICAL FIELD

The present disclosure is related to a battery output control technique, and more particularly, to a battery output control device implemented to prevent a battery from being used beyond a battery output limit value, a battery output control method thereof, and an eco-friendly vehicle equipped with the same.

### BACKGROUND

The matters described in this Background section are only for enhancement of understanding of the background of the disclosure, and should not be taken as acknowledgment that they correspond to prior art already known to those skilled in the art.

An eco-friendly vehicle may be equipped with a power electronics (PE) system for driving and may include a driving motor, an inverter, a battery management system, a battery, etc.

An eco-friendly vehicle may perform battery output limit control to limit battery output in order to protect the battery when a cell voltage falls below a certain value, thereby preventing further decrease in cell voltage.

To this end, the battery management system may store an output map including output limit values for respective driving motor operating areas, and a vehicle controller may receive the output map from the battery management system and perform output limit control with reference to the output map in a process of generating required output.

Although PE system efficiency may differ by driving motor operating area (temperature/rpm/torque, etc.), it is not practical to test the efficiency for the entire area, and thus the output limit values constituting the output map may be representative values (room temperature efficiency values) for respective driving motor operating areas.

Therefore, unlike the conditions when setting the representative values of the output map, the accuracy of the output limit values may decrease in situations such as extremely low/high temperatures, and the vehicle controller may compensate for and utilize the output limit values.

There may be limitations in vehicle evaluation and fine tuning for all areas (SoC, temperature, torque level, etc.) used in the PE system, and since the vehicle controller compensates for output limit values based on feedback control, there may be limitations in resolving problems caused by use beyond an output limit.

### SUMMARY

According to the present disclosure, an apparatus of a vehicle, the apparatus may comprise a processor and a memory storing at least one instruction that is configured, when executed by the processor communicating with the memory, to cause the apparatus to determine, based on a monitored output value, of a battery of the vehicle, exceeding an allowable output value of the battery, a new output limit value of the battery for reducing a difference between the monitored output value of the battery and a preset initial output limit value of the battery, change the preset initial output limit value to the new output limit value such that an output of the battery is controlled by the new output limit value, and perform, based on the output of battery being controlled by the new output limit value, at least one operation of the vehicle.

The apparatus, wherein the at least one instruction is configured, when executed by the processor communicating with the memory, to cause the apparatus to compare the preset initial output limit value with the monitored output value of the battery to determine the difference, wherein the preset initial output limit value is associated with a monitored state of charge of the battery and a temperature of the battery.

The apparatus, wherein the at least one instruction is configured, when executed by the processor communicating with the memory, to cause the apparatus to determine whether the difference satisfies update conditions, and calculate, based on the difference satisfying the update conditions for changing the preset initial output limit value, the new output limit value.

The apparatus, wherein the at least one instruction is configured, when executed by the processor communicating with the memory, to cause the apparatus to compare an integral value of the difference with a preset threshold value, and calculate, based on the integral value exceeding the preset threshold value, the new output limit value.

The apparatus, wherein the at least one instruction that is configured, when executed by the processor communicating with the memory, to cause the apparatus to compare an integral value of the difference with a preset threshold value, determine, based on the integral value exceeding the preset threshold value, a duration of time in which the monitored output value of the battery exceeds the allowable output value of the battery, and calculate, based on the duration of time exceeding a preset threshold duration value, the new output limit value.

The apparatus, wherein the at least one instruction is configured, when executed by the processor communicating with the memory, to cause the apparatus to determine whether a preset initialization event has occurred, and initialize, based on an occurrence of the preset initialization event, the new output limit value to the initial output limit value. The apparatus, wherein the at least one instruction is configured, when executed by the processor communicating with the memory, to cause the apparatus to initialize, based on receiving a vehicle power off signal, the new output limit value to the preset initial output limit value.

The apparatus, wherein the at least one instruction is configured, when executed by the processor communicating with the memory, to cause the apparatus to calculate the new output limit value such that the difference between the monitored output value of the battery and the preset initial output limit value becomes zero.

According to the present disclosure, a method performed by an apparatus of a vehicle, the method may comprise monitoring an output value of a battery of the vehicle, determining, based on a difference between the monitored output value of the battery and a preset initial output limit value of the battery, whether the monitored output value of the battery exceeds an allowable output value of the battery, determining, based on the monitored output value exceeding the allowable output value, a new output limit value for reducing the difference between the monitored output value and the preset initial output limit value, changing the preset initial output limit value to the new output limit value such that an output of the battery is controlled by the new output limit value, and performing, based on the output of battery being controlled by the new output limit value, at least one operation of the vehicle.

The method, wherein the determining whether the monitored output value of the battery exceeds the allowable output value of the battery may comprise comparing the preset initial output limit value with the monitored output value, wherein the preset initial output limit value is associated with a monitored state of charge of the battery and temperature of the battery.

The method may further comprise determining, based on the monitored output value of the battery exceeding the allowable output value of the battery, whether the difference satisfies update conditions for changing the preset initial output limit value, wherein the determining the new output limit value may comprise calculating, based on the difference satisfying the update conditions, the new output limit value. The method, wherein the determining whether the difference satisfies the update conditions may comprise comparing an integral value of the difference with a preset threshold value, and determining whether the integral value exceeds the preset threshold value.

The method, wherein the calculating the new output limit value is based on the integral value exceeding the preset threshold value.

The method, wherein the determining whether the difference satisfies the update conditions may comprise comparing an integral value of the difference with a preset threshold value, determining, based on the integral value exceeding the preset threshold value, a duration of time in which the monitored output value of the battery exceeds the allowable output value of the battery, and determining whether the duration of time exceeds a preset threshold duration value.

The method, wherein the determining the new output limit value may comprise calculating, based on the duration of time exceeding the preset threshold duration value, the new output limit value.

The method may further comprise determining whether a preset initialization event has occurred, and initializing, based on an occurrence of the preset initialization event, the new output limit value to the preset initial output limit value.

The method, wherein the determining whether the preset initialization event has occurred may comprise determining whether a vehicle power off signal is received.

The method, wherein the determining the new output limit value may comprise calculating the new output limit value such that the difference between the monitored output value of the battery and the preset initial output limit value becomes zero.

According to the present disclosure, an apparatus of a vehicle, the apparatus may comprise a battery of the vehicle, a processor, and a memory storing at least one instruction that is configured, when executed by the processor communicating with the memory, to cause the apparatus to adjust, based on a monitored output value of the battery exceeding an allowable range of output values of the battery for a period of time longer than a threshold time, an initial output limit value of the battery wherein the adjusted output limit value is less than the initial output limit value, and control, based on the adjusted output limit value, a peak output of the battery, and perform, based on the peak output of battery being controlled by the adjusted output limit value, at least one operation of the vehicle.

The apparatus, wherein the at least one instruction is configured, when executed by the processor communicating with the memory, to cause the apparatus to reset, based on receiving a reset signal of the vehicle, the adjusted output limit value back to the initial output limit value.

Specific details according to various examples of the present disclosure other than the means for solving the above-mentioned problems are included in the description and drawings below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of a configuration of a vehicle including a battery output control device according to an example of the present disclosure;

FIG. 2 shows an example of a configuration of the battery output control device according to an example of the present disclosure;

FIG. 3 shows an example of a battery output control method according to an example of the present disclosure;

FIG. 4 shows an example in which an error ΔW is generated when an actual output exceeds an output limit value;

FIG. 5 shows an example in which an actual output follows an initial output limit value and thus an error ΔW converges on 0 when a new output limit value according to an example of the present disclosure is applied;

FIG. 6 is a graph showing an actual output; and

FIG. 7 is a graph showing an actual output when battery output control according to an example of the present disclosure is performed.

### DETAILED DESCRIPTION

In the following description, a detailed description of known functions and configurations incorporated herein will be omitted when it may obscure the subject matter of the present disclosure. The same reference numbers will be used in the drawings to refer to the same or like parts. In addition, the attached drawings are only intended to facilitate easy understanding of the examples disclosed in this specification, and the technical ideas disclosed in this specification are not limited by the attached drawings, and should be understood to include all modifications, equivalents, or substitutes included in the spirit and technical scope of the present disclosure.

Terms such as “first” and/or “second” are used to describe various components, but such components are not limited by these terms. The terms are used to discriminate one component from another component.

An element described in the singular form is intended to include a plurality of elements unless the context clearly indicates otherwise.

In the present specification, the term “comprise” or “include” is intended to specify the presence of a described feature, number, step, operation, component, part, or a combination thereof, but should be understood as not excluding the possibility of the presence or addition of one or more other features, numbers, steps, operations, components, parts, or combinations thereof.

may

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

In the present disclosure, the “system” may include at least one device among a computing device, a network device, a controller, a vehicle device, a server device, and/or a cloud device, but is not limited thereto. For example, the system may include (or configured with) one or more server devices. As another example, the system may include (or configured with) one or more cloud devices. As another example, the system may operate by a server device and a cloud device.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

Hereinafter, examples disclosed in this specification will be described in detail with reference to the attached drawings. Regardless of the drawing symbols, identical or similar components will be given the same reference numerals and redundant description thereof will be omitted.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of dynamically adjusted power output limit of a battery of a vehicle) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of dynamically adjusted power output limit of a battery of a vehicle) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of dynamically adjusted power output limit of a battery of a vehicle) described herein.

Minimum risk maneuver (MRM) operation(s) may also be controlled, for example, based on one or more features (e.g., features of dynamically adjusted power output limit of a battery of a vehicle) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of dynamically adjusted power output limit of a battery of a vehicle) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of dynamically adjusted power output limit of a battery of a vehicle) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

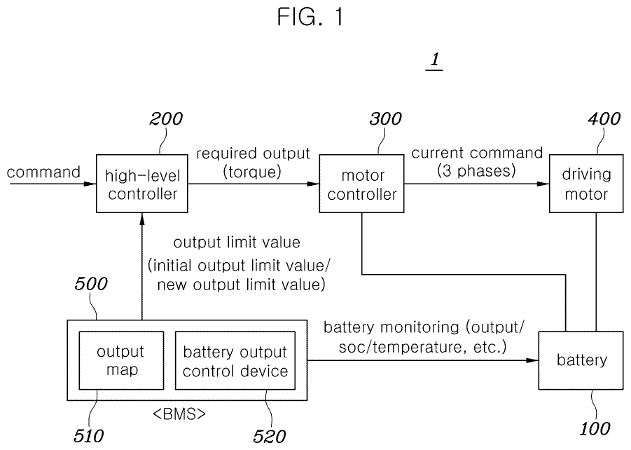

FIG. 1 shows an example of a configuration of a vehicle 1 including a battery output control device according to an example of the present disclosure.

Referring to FIG. 1, a transportation system (e.g., the vehicle 1) may be an eco-friendly vehicle equipped with a power electronics (PE) system for driving. For example, the vehicle 1 may be an electric vehicle (EV), a hybrid electric vehicle (HEV), a plug-in hybrid electric vehicle (PHEV), a fuel cell electric vehicle (FCEV), or the like.

According to the example, the vehicle 1 may include a battery 100, a high-level controller 200, a motor controller 300, a driving motor 400, and a battery controller 500, but the configuration of the vehicle 1 is not limited thereto.

The battery 100 may include a plurality of cells (e.g., lithium-ion cells, solid-state cells, nickel-metal hydride cells, or lithium-iron-phosphate cells, etc.), and the battery controller 500 may monitor the state of the battery 100 and control the output of the battery 100.

The battery 100 may supply power to components in the vehicle 1, and for example, may supply power to the motor controller 300 and the driving motor 400, and the components (e.g., auxiliary systems such as climate control, infotainment, lighting, and safety systems, etc.) to which the power from the battery 100 is supplied are not limited thereto.

The state of the battery 100 is monitored by the battery controller 500, and power may be supplied according to control of the battery controller 500.

The high-level controller 200 may generate and output required power based on an input command. For example, the high-level controller 200 may receive an accelerator pedal input value (e.g., an accelerator pedal position value) detected by an accelerator pedal sensor or a brake pedal input value detected by a brake pedal sensor or other driver input signals (e.g., regenerative braking engagement, cruise control activation, or torque request modifications, etc.) as a command.

For example, the high-level controller 200 may include a hybrid control unit (HCU), a vehicle control unit (VCU), an integrated central control unit (ICU), a powertrain control module (PCM), or an energy management system (EMS), etc., and the like, but is not limited thereto.

The high-level controller 200 may limit the output of the battery 100 using an adaptive output map stored in the battery controller 500 in a process of generating required power.

The motor controller 300 may generate and output a current command corresponding to the required power output from the high-level controller 200 based on the output of the battery 100.

The motor controller 300 may include an inverter that converts DC power output from the battery 100 into AC power and outputs the AC power to the driving motor 400. The inverter may be implemented in a structure selected from among various inverter structures (e.g., multi-level inverters, pulse-width modulation (PWM) inverters, resonant inverters, or voltage-source inverters, etc.), and a detailed description thereof will be omitted.

The driving motor 400 is controlled by the motor controller 300 and may output driving power corresponding to the current command output from the motor controller 300.

The battery controller 500 may monitor operating parameters of the battery 100, for example, including the power output, state of charge (SoC), temperature, voltage, current, resistance, degradation level, and the like, and control the output of the battery 100.

For example, the battery controller 500 may be a battery management system (BMS).

According to an example, the battery controller 500 may include a memory 510 in which an output map is stored, and a battery output control device 520.

Here, the output map includes output limit values for respective driving motor operation areas, and may be used to limit the output of the battery in the process in which the high-level controller 200 generates required power.

The output map (“initial output map”) previously stored in the memory 510 is set depending on the SoC and thermal state (e.g., temperature) of the battery and may be represented in the form of a multi-dimensional lookup table (e.g., a 2D, 3D, or higher-order map). For example, the output limit values (“initial output limit values”) constituting the previously stored output map (initial output map) may be set through a PE system efficiency test (e.g., dynamometer tests, thermal cycle analysis, or computational modeling, etc.).

According to an example, the initial output map stored in the memory 510 may be changed (or updated) by the battery output control device 520. That is, the initial output limit values constituting the initial output map may be changed (or updated or adjusted) by the battery output control device 520.

According to an example, the output map (“new output map”) changed (or updated or adjusted) by the battery output control device 520 may be initialized to the initial output map if a preset event occurs (e.g., vehicle shutdown, maintenance mode activation, or battery fault detection, etc.). For example, if a vehicle ignition is turned off, the new output map may be initialized to the initial output map, and the type of event in which the new output map is initialized is not limited thereto.

In an example of the present disclosure, the battery output control device 520 may be implemented within the battery controller 500, but is not limited thereto. For example, the battery output control device 520 may be implemented separately from the battery controller 500.

The battery output control device 520 may monitor operating parameters of the battery 100, for example, including the power output, state of charge (SoC), temperature, voltage, current, internal resistance, and the like, and control the output of the battery 100.

According to an example, the battery output control device 520 may change an initial output limit value based on a result of comparing a battery output value (e.g., a real-time power output value) with the initial output limit value.

Here, the battery output control device 520 may compare an initial output limit value selected based on the monitored SoC and thermal state (e.g., temperature or fluctuations in temperature) of the battery 100 with the battery output value (e.g., real-time power output value of the battery 100).

For example, the battery output control device 520 may search an initial output map stored in the memory 510 for an initial output limit value corresponding to the monitored SoC and thermal state (e.g., temperature decrease or increase) of the battery 100 and compare the searched initial output limit value with the battery output value (e.g., a real-time power output value).

According to an example, the battery output control device 520 may determine that a situation in which an allowable output of the battery 100 is exceeded has occurred if the battery output value is greater than the initial output limit value as a result of comparing the battery output value with the initial output limit value, and calculate or determine a new output limit value.

For example, the battery output control device 520 may calculate or determine a new output limit value for reducing the difference between the battery output value and the initial output limit value based on adaptive feedback control (e.g., proportional control, fuzzy logic control, or neural network-based control, etc.). For example, the battery output control device 520 may calculate or determine a new output limit value that makes the difference between the battery output value and the initial output limit value approach zero.

For example, the battery output control device 520 may comprise a controller that implements a proportional-integral-differential (PID) controller, model predictive controller (MPC), or reinforcement learning-based controller, etc., and may calculate or determine a new output limit value through adaptive feedback control performed based on the controller.

According to an example, the battery output control device 520 may compare an integrated value or an accumulated deviation value(integral value) of the difference between the battery output value (e.g., a real-time power output value) and the initial output limit value with a preset critical value (e.g., a preset threshold limit), and calculate or determine a new output limit value if the integral value or an accumulated deviation value exceeds the threshold limit.

For example, the critical value may represent an acceptable deviation range for the difference and may be set through a battery safety test (e.g., cyclic charge-discharge testing, thermal stress testing, or accelerated aging tests, etc.).

By setting the critical value or the threshold limit (acceptable deviation range) in this manner, it is possible to ensure the safety and/or longevity of the battery 100 while preventing excessive use of the battery output control device 520.

According to the example, the battery output control device 520 may determine a time (“duration” or “deviation duration”) for which a state in which the allowable power output is exceeded is maintained, compare the deviation duration with a preset critical duration value (e.g., a preset critical deviation duration time), and calculate or determine a new output limit value if the deviation duration exceeds the critical deviation time.

For example, the critical duration value (critical deviation duration time) may be set through a battery safety test (e.g., cyclic charge-discharge testing, thermal stress testing, or accelerated aging tests, etc.), and by setting the critical duration value, the safety of the battery 100 may be ensured and excessive use of or reliance on the battery output control device 520 may be prevented.

For example, the critical duration value (critical deviation duration time) may be set differently depending on the difference (e.g., a magnitude of the deviation) between the battery output value (e.g., a real-time power output value) and the initial output limit value, and may be set inversely proportional to the difference (e.g., the magnitude of the deviation). That is, the critical duration value (critical deviation duration time) may be set to be lower or shorter as the difference (deviation) increases.

Since the safety problem (e.g., degradation) of the battery 100 may be aggravated as the difference (deviation) increases, the reliability and safety of the battery 100 may be ensured by setting the critical duration value inversely proportional to the difference (e.g., a magnitude of the deviation).

In this manner, the battery output control device 520 may determine whether the (deviation) duration exceeds the critical duration value (e.g., critical deviation duration time), which corresponds to the difference (e.g., a magnitude of the deviation), and calculate or determine a new output limit value if the (deviation) duration exceeds the critical duration value.

The battery output control device 520 may change or adjust (or update) the initial output map based on the calculate or determined new output limit value to generate a new output map.

Accordingly, the high-level controller 200 may limit or control the output of the battery 100 using the new output map in the process of generating a required output.

The battery output control device 520 may store the initial output map before updating the initial output map.

According to the example, the battery output control device 520 may initialize or reset the new output map to the initial output map when a preset event occurs (e.g., system restart, software update, or emergency shutdown, etc.).

For example, the battery output control device 520 may initialize or reset the new output map to the initial output map if vehicle ignition is turned off.

To achieve this, the battery output control device 520 may receive a vehicle system status signal (e.g., a vehicle ignition status signal), and if a system shutdown signal (e.g., vehicle power-off (IG OFF) signal, battery disconnect event, or fault detection trigger, etc.) is received, initialize or reset the new output map to the initial output map.

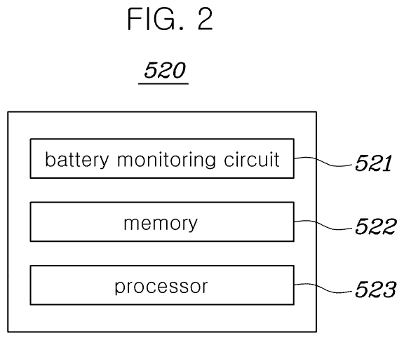

FIG. 2 shows an example of a configuration of the battery output control device 520 according to an example of the present disclosure.

Referring to FIG. 2, the battery output control device 520 may include a battery monitoring circuit 521, a memory 522, and a processor 523, and the configuration of the battery output control device 520 is not limited thereto.

The battery monitoring circuit 521 may be implemented to be able to monitor or track the state of the battery 100 (e.g., the power output, state of charge (SoC), temperature, voltage, current, internal resistance, degradation state, and other operational parameters).

The memory 522 may store control logic or data (e.g., an algorithm, operational thresholds, calibration data, historical performance metrics, or other system-related parameters, etc.) for the operation of the battery output control device 520. For example, the memory 522 may store an algorithm, data (e.g., environmental adjustment factors, predefined safety limits, or learned operational patterns, etc.) required to perform the battery output control function of the battery output control device 520.

According to an example, the memory 522 may store a battery output control algorithm, threshold values, critical values, a critical duration value, fail-safe parameters, or error correction routines, etc.

For example, the memory 522 may be implemented as at least one of storage media (or recording media) among a flash memory, a hard disk, a secure digital (SD) card, a random access memory (RAM), a static random access memory (SRAM), a read only memory (ROM), a programmable read only memory (PROM), an electrically erasable and programmable ROM (EEPROM), an erasable and programmable ROM (EPROM), a register, a removable disk, and web storage, solid-state drives (SSD), embedded multi-media cards (eMMC), non-volatile memory express (NVMe), phase-change memory (PCM), resistive RAM (ReRAM), or cloud-based storage solutions, etc.

The processor 523 may perform battery output control based on status information (e.g., real-time operational status) of the battery 100 monitored by the battery monitoring circuit 521 and the algorithm/data (e.g., optimization routines or adaptive learning models, etc.) stored in the memory 522.

The processor 523 may be a hardware-implemented data processing device including a circuit having a physical structure for executing desired operations (e.g., a microprocessor, a central processing unit (CPU), a digital signal processor (DSP), a graphics processing unit (GPU) for parallel computations, a multi-core processor, a multiprocessor, an application-specific integrated circuit (ASIC), a field-programmable gate array (FPGA), a neuromorphic processing unit, or a tensor processing unit (TPU), etc.). For example, the desired operations may include code or instructions included in a program. For example, the desired operations may comprise arithmetic operations, logical operations such as AND, OR, NOT, and comparisons, data transfer operations for moving data between memory and registers, control flow operations that dictate the sequence of instructions, like branching and looping, bit manipulation operations for individual bit control, or specialized floating-point operations for decimal number calculations, etc.

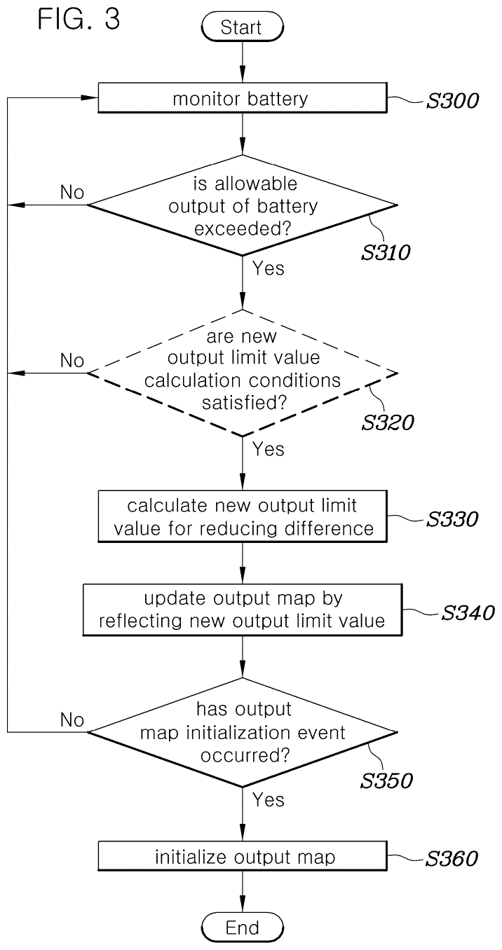

FIG. 3 shows an example of a battery output control method according to an example of the present disclosure.

The step-by-step operation (battery output control method) shown in FIG. 3 may be performed by the battery output control device 520 described with reference to FIG. 1 and FIG. 2.

Referring to FIG. 3, the battery output control device 520 may monitor the battery 100 (S300).

In step S300, the battery output control device 520 may monitor a state of the battery 100 (e.g., the power output, state of charge (SoC), temperature, voltage, current, internal resistance, power demand fluctuations, other operational parameters, etc.)

Thereafter, the battery output control device 520 may determine whether a state in which an allowable output of the battery 100 is exceeded has occurred based on the difference between the monitored battery output value (e.g., a real-time power output value) and an initial output limit value stored in the memory 510 (S310).

In step S310, the battery output control device 520 may search the initial output map (e.g., power output map) stored in the memory 510 for an initial output limit value corresponding to the monitored SoC and temperature of the battery 100, and compare the corresponding initial output limit value with the battery output value (e.g., monitored real-time power output value).

In step S310, the battery output control device 520 may determine that a state in which the allowable output threshold is exceeded has occurred if the battery output value (e.g., monitored real-time power output value) is greater than the initial output limit value.

If a state (e.g., an exceeded state) in which the allowable output threshold is exceeded has occurred (i.e., if the monitored real-time power output value of the battery is greater than the initial output limit value) (S310-Yes), the battery output control device 520 may determine whether the difference satisfies new output limit value recalculation condition or calculation conditions (S320).

According to the example, step S320 may be omitted, and the battery output control device 520 may calculate or determine a new output limit value in step S330 upon determining that a state is the exceeded state in which the allowable output is exceeded has occurred in step S310.

In step S320, the battery output control device 520 may compare the integrated value (e.g., cumulative deviation) of the difference between the battery output value and the initial output limit value with a preset critical value (e.g., a preset threshold deviation limit), and determine whether the integrated value exceeds the preset threshold deviation limit.

If the integrated value exceeds the preset threshold deviation limit, the battery output control device 520 may determine that the difference satisfies the new output limit value calculation conditions.

In step S320, if the integrated value exceeds the critical value, the battery output control device 520 may determine a duration (e.g., “a power exceedance duration”) for which the state (e.g., the exceeded stat) in which the allowable output is exceeded is maintained or continued, compare the duration with a preset critical duration value, and further determine whether the duration exceeds the preset critical duration value.

Upon determining that the duration exceeds the preset critical duration value, the battery output control device 520 may further determine that the difference satisfies the new output limit value calculation conditions. For example, if a monitored output power of the battery exceeds an initial power output limit value for a sustained period of time (e.g., a period longer than a preset period of time), the initial power output limit value may be updated (e.g., set to a different value) to reduce an output power deviation or ensure future power output of the battery stays within allowable range.

If the difference satisfies the new output limit value calculation conditions (S320—Yes), the battery output control device 520 may calculate or determine or recalculate or determine a new output limit value for reducing the difference between the battery output value and the initial output limit value (S330).

In step S320, the battery output control device 520 may calculate or determine a new output limit value that makes the difference between the battery output value and the initial output limit value approach zero through adaptive feedback control (e.g., PID control, fuzzy logic control, or reinforcement learning-based control, etc.).

Thereafter, the battery output control device 520 may reflect the new output limit value to the initial output map to update the initial output map (S340), thereby generating a new output map (e.g., power output map).

The battery output control device 520 may store the initial output map before updating the initial output map.

According to the example, the battery output control device 520 may further determine whether a preset output map initialization event has occurred (S350).

In step S350, the battery output control device 520 may determine whether a system shutdown signal (e.g., a vehicle power off (IG OFF) signal, emergency reset, maintenance mode activation, or thermal runaway prevention, etc.) is inputted or received.

If the output map initialization event or a power output map reset event has occurred (S350—Yes), the battery output control device 520 may initialize or reset the new output map to the initial output map (S360). For example, the new output limit value (e.g., a lowered power output limit value) may be reset to the initial output limit value (e.g., a power output limit value higher than the new output limit value) as the new output map is reset to the initial output map.

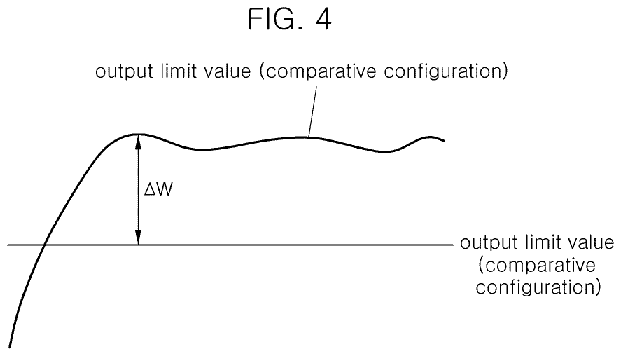

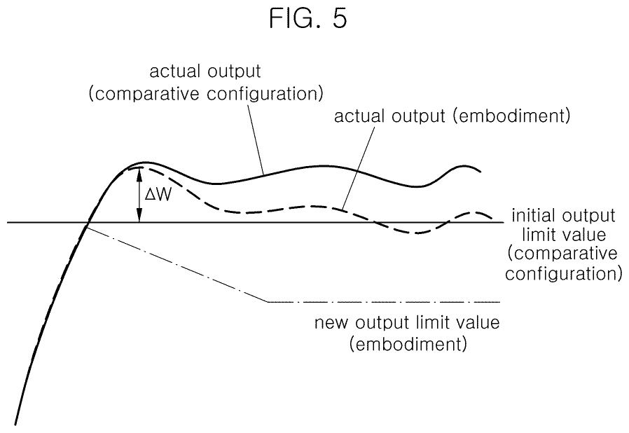

FIG. 4 shows an example in which an output deviation (e.g., an error ΔW) is generated if an actual output (e.g., a real-time power output) exceeds an output limit value (e.g., a preset power output limit value) when battery output control is performed without implementing the features according to the present disclosure. FIG. 5 shows an example in which an actual output (e.g., a real-time power output) follows an initial output limit value and thus an output deviation (e.g., an error ΔW) converges on zero when a new dynamically adjusted power output limit (e.g., a new output limit value) according to an example of the present disclosure is applied.

As shown in FIG. 4, the actual output exceeds the output limit value, and thus the error ΔW may occur between the actual output and the output limit value. In comparison, as shown in FIG. 5, if a new dynamically adjusted output limit value is applied as an output limit value of the battery according to the battery output control method according to the example of the present disclosure, the real-time power output of the battery is limited by the new dynamically adjusted output limit value. Accordingly, the real-time power output of the battery is constrained within the new dynamically adjusted output limit value, ensuring that the real-time power output aligns with the initial output limit value, thereby allowing the output deviation (e.g., the error ΔW between the actual output and the initial output limit value) may to gradually diminish and reach zero (e.g., converge on 0).

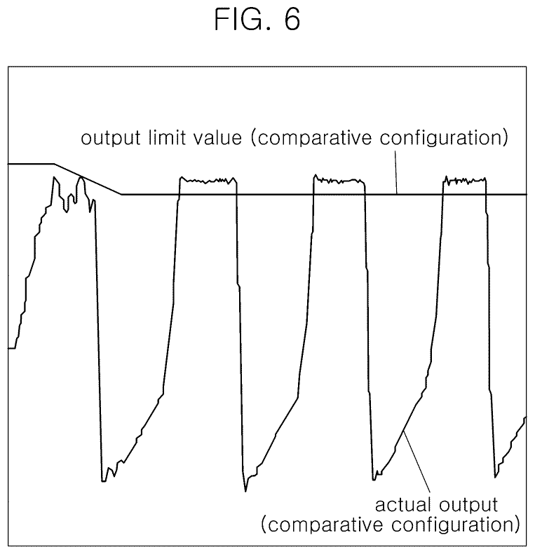

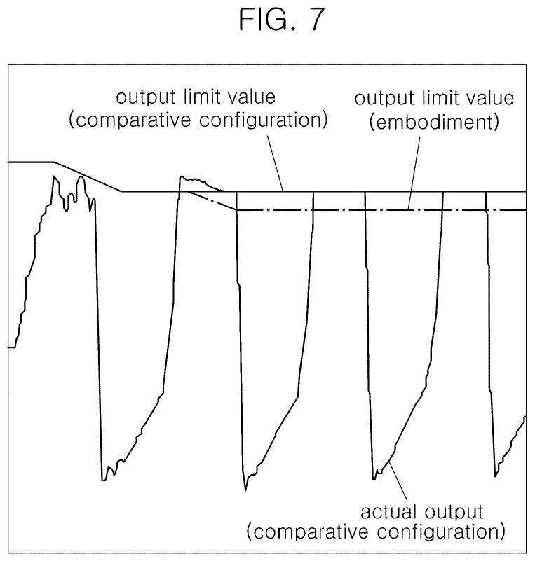

FIG. 6 is a graph showing fluctuations in actual output (e.g., a real-time power output) of a battery when battery output control is performed without implementing the techniques according to the present disclosure. FIG. 7 is a graph showing stabilized power output response when adaptive battery output control according to an example of the present disclosure is performed.

As shown in FIG. 6, when battery output control is performed without implementing the techniques according to the present disclosure, the actual output may frequently exceed the output limit value, leading to potential battery stress, increased heat generation, or accelerated degradation of the battery.

However, as shown in FIG. 7, when adaptive battery output control is performed by applying the dynamically adjusted output limit value according to the example of the present disclosure, the real-time power output of the battery remains within a prescribed safe limit, ensuring that the power output of the battery remains stable without exceeding the previously encountered excessive output levels.

Examples of the present disclosure are proposed in accordance with the above-described needs, and an object of the present disclosure is to provide a battery output control device implemented to prevent a battery from being used beyond a battery output limit value, a battery output control method thereof, and an eco-friendly vehicle equipped with the same.

Another object of the examples of the present disclosure is to provide a battery output control device implemented to calculate or determine a new output limit value for reducing the difference between a battery output value and a preset initial output limit value if a battery allowable output is exceeded, and to change the initial output limit value to the new output limit value such that battery output is limited by the new output limit value, a battery output control method thereof, and an eco-friendly vehicle equipped with the same.

Another object of the examples of the present disclosure is to provide a battery output control device implemented to further determine whether the difference between the output value of the battery and the preset initial output limit value satisfies new output limit value calculation conditions, and to calculate or determine the new output limit value if the difference satisfies the new output limit value calculation conditions, a battery output control method thereof, and an eco-friendly vehicle equipped with the same.

The objects to be achieved in the present disclosure are not limited to the objects mentioned above, and other technical objects not mentioned will be clearly understood by those skilled in the art to which the present disclosure belongs from the description below.

In accordance with an aspect of the present disclosure, the above and other objects may be accomplished by the provision of a device for controlling output of a battery equipped in a vehicle, wherein the device calculate or determines a new output limit value for reducing a difference between a monitored output value of the battery and a preset initial output limit value upon determining that a situation in which an allowable output of the battery is exceeded has occurred based on the difference, and changes the initial output limit value to the new output limit value such that the output of the battery is limited by the new output limit value.

According to an example of the present disclosure, the device may compare the initial output limit value corresponding to a monitored state of charge and temperature of the battery with the output value to determine the difference.

According to an example of the present disclosure, the device may further determine whether the difference satisfies new output limit value calculation conditions, and calculate or determine the new output limit value if the difference satisfies the new output limit value calculation conditions.

According to an example of the present disclosure, the device may compare the integral value of the difference with a preset critical value, and calculate or determine the new output limit value if the integral value exceeds the critical value.

According to an example of the present disclosure, the device may compare the integral value of the difference with the preset critical value, determine a duration of the situation in which the allowable output is exceeded if the integral value exceeds the critical value, and calculate or determine the new output limit value if the duration exceeds a preset critical duration value.

According to an example of the present disclosure, the device may further determine whether a preset initialization event has occurred, and initialize the new output limit value to the initial output limit value if the initialization event has occurred.

According to an example of the present disclosure, the device may initialize the new output limit value to the initial output limit value if a vehicle power off signal is input.

According to an example of the present disclosure, the device may calculate or determine the new output limit value such that the difference between the output value and the initial output limit value becomes 0.

In accordance with another aspect of the present disclosure, there is provided a method performed by a device for controlling output of a battery equipped in a vehicle, the method including monitoring, by the device, the battery, determining, by the device, whether a situation in which an allowable output of the battery is exceeded has occurred based on a difference between a monitored output value of the battery and a preset initial output limit value, calculating, by the device, a new output limit value for reducing the difference when a situation in which the allowable output is exceeded has occurred, and changing, by the device, the initial output limit value to the new output limit value such that the output of the battery is limited by the new output limit value.

According to an example of the present disclosure, the determining may include comparing the initial output limit value corresponding to a monitored state of charge and temperature of the battery with the output value.

According to an example of the present disclosure, the method may further include determining whether the difference satisfies new output limit value calculation conditions when a situation in which the allowable output is exceeded has occurred, wherein if the difference satisfies the new output limit value calculation conditions, the calculating the new output limit value may be performed.

According to an example of the present disclosure, the determining whether the difference satisfies the new output limit value calculation conditions may include the integral value of the difference with a preset critical value, and determining whether the integral value exceeds the critical value.

According to an example of the present disclosure, the calculating the new output limit value may be performed if the integral value exceeds the critical value.

According to an example of the present disclosure, the determining whether the difference satisfies the new output limit value calculation conditions may include comparing the integral value of the difference with a preset critical value, determining a duration of the state in which the allowable output is exceeded if the integral value exceeds the critical value, and determining whether the duration exceeds a preset critical duration value.

According to an example of the present disclosure, the calculating the new output limit value may be performed if the duration exceeds the critical duration value.

According to an example of the present disclosure, the method may further include determining whether a preset initialization event has occurred, and initializing the new output limit value to the initial output limit value if the initialization event has occurred.

According to an example of the present disclosure, the determining whether a preset initialization event has occurred may include determining whether a vehicle power off signal is input.

According to an example of the present disclosure, the calculating the new output limit value may include calculating the new output limit value such that the difference between the output value and the initial output limit value becomes 0.

In accordance with another aspect of the present disclosure, there is provided an eco-friendly vehicle including a battery, and a device for controlling output of the battery, wherein the device calculate or determines a new output limit value for reducing a difference between a monitored output value of the battery and a preset initial output limit value upon determining that a situation in which an allowable output of the battery is exceeded has occurred based on the difference, and changes the initial output limit value to the new output limit value such that the output of the battery is limited by the new output limit value.

In a case where battery output exceeds allowable output of the battery, the examples of the present disclosure may calculate or determine a new dynamically adjusted output limit value for reducing the difference between a real-time power output value of the battery and a preset initial output limit value, and change the initial output limit value to the new dynamically adjusted output limit value such that battery output is limited, constrained or controlled by the new dynamically adjusted output limit value.

When battery output control is performed using the new dynamically adjusted output limit value for reducing the difference between the output value of the battery and the initial output limit value, the actual output follows or conforms to the initial output limit value, and thereby preventing the output of the battery may from exceeding the original safe operating threshold (e.g., the initial output limit value).

In addition, the examples of the present disclosure may further determine whether the difference between the output value (a real-time power output) of the battery and the initial output limit value satisfies new output limit value calculation conditions, and if the conditions are satisfied, calculate or determine the new dynamically adjusted output limit value accordingly.

When the new dynamically adjusted output limit value calculation conditions are applied, resources (e.g., computational resources, energy consumption, or processing time, etc.) required to calculate or determine the new dynamically adjusted output limit value and change the output limit value may be reduced and battery safety may be ensured.

The effects that may be obtained from the present disclosure are not limited to the effects mentioned above, and other effects not mentioned may be clearly understood by those skilled in the art to which the present disclosure belongs from the description below.

Although the preferred examples of the present disclosure have been disclosed for exemplary purposes, those skilled in the art will appreciate that various modifications, additions and substitutions are possible, without departing from the scope and spirit of the disclosure as disclosed in the accompanying claims.

What is claimed:

1. An apparatus of a vehicle, the apparatus comprising:
a processor; and
a memory storing at least one instruction that is configured, when executed by the processor communicating with the memory, to cause the apparatus to:
determine, based on a monitored output value, of a battery of the vehicle, exceeding an allowable output value of the battery, a new output limit value of the battery for reducing a difference between the monitored output value of the battery and a preset initial output limit value of the battery,
change the preset initial output limit value to the new output limit value such that an output of the battery is controlled by the new output limit value, and
perform, based on the output of battery being controlled by the new output limit value, at least one operation of the vehicle.

2. The apparatus of claim 1, wherein the at least one instruction is configured, when executed by the processor communicating with the memory, to cause the apparatus to compare the preset initial output limit value with the monitored output value of the battery to determine the difference, wherein the preset initial output limit value is associated with a monitored state of charge of the battery and a temperature of the battery.

3. The apparatus of claim 1, wherein the at least one instruction is configured, when executed by the processor communicating with the memory, to cause the apparatus to:
determine whether the difference satisfies update conditions, and
calculate, based on the difference satisfying the update conditions for changing the preset initial output limit value, the new output limit value.

4. The apparatus of claim 3, wherein the at least one instruction is configured, when executed by the processor communicating with the memory, to cause the apparatus to:
compare an integral value of the difference with a preset threshold value, and
calculate, based on the integral value exceeding the preset threshold value, the new output limit value.

5. The apparatus of claim 3, wherein the at least one instruction that is configured, when executed by the processor communicating with the memory, to cause the apparatus to:
compare an integral value of the difference with a preset threshold value,
determine, based on the integral value exceeding the preset threshold value, a duration of time in which the monitored output value of the battery exceeds the allowable output value of the battery, and
calculate, based on the duration of time exceeding a preset threshold duration value, the new output limit value.

6. The apparatus of claim 1, wherein the at least one instruction is configured, when executed by the processor communicating with the memory, to cause the apparatus to:
determine whether a preset initialization event has occurred, and
initialize, based on an occurrence of the preset initialization event, the new output limit value to the initial output limit value.

7. The apparatus of claim 6, wherein the at least one instruction is configured, when executed by the processor communicating with the memory, to cause the apparatus to initialize, based on receiving a vehicle power off signal, the new output limit value to the preset initial output limit value.

8. The apparatus of claim 1, wherein the at least one instruction is configured, when executed by the processor communicating with the memory, to cause the apparatus to calculate the new output limit value such that the difference between the monitored output value of the battery and the preset initial output limit value becomes zero.

9. A method performed by an apparatus of a vehicle, the method comprising:
monitoring an output value of a battery of the vehicle;
determining, based on a difference between the monitored output value of the battery and a preset initial output limit value of the battery, whether the monitored output value of the battery exceeds an allowable output value of the battery;
determining, based on the monitored output value exceeding the allowable output value, a new output limit value for reducing the difference between the monitored output value and the preset initial output limit value;
changing the preset initial output limit value to the new output limit value such that an output of the battery is controlled by the new output limit value; and
performing, based on the output of battery being controlled by the new output limit value, at least one operation of the vehicle.

10. The method of claim 9, wherein the determining whether the monitored output value of the battery exceeds the allowable output value of the battery comprises comparing the preset initial output limit value with the monitored output value, wherein the preset initial output limit value is associated with a monitored state of charge of the battery and temperature of the battery.

11. The method of claim 9, further comprising:
determining, based on the monitored output value of the battery exceeding the allowable output value of the battery, whether the difference satisfies update conditions for changing the preset initial output limit value,
wherein the determining the new output limit value comprises calculating, based on the difference satisfying the update conditions, the new output limit value.

12. The method of claim 11, wherein the determining whether the difference satisfies the update conditions comprises:
comparing an integral value of the difference with a preset threshold value, and
determining whether the integral value exceeds the preset threshold value.

13. The method of claim 12, wherein the calculating the new output limit value is based on the integral value exceeding the preset threshold value.

14. The method of claim 11, wherein the determining whether the difference satisfies the update conditions comprises:
comparing an integral value of the difference with a preset threshold value,
determining, based on the integral value exceeding the preset threshold value, a duration of time in which the monitored output value of the battery exceeds the allowable output value of the battery, and
determining whether the duration of time exceeds a preset threshold duration value.

15. The method of claim 14, wherein the determining the new output limit value comprises: calculating, based on the duration of time exceeding the preset threshold duration value, the new output limit value.

16. The method of claim 9, further comprising:
determining whether a preset initialization event has occurred; and
initializing, based on an occurrence of the preset initialization event, the new output limit value to the preset initial output limit value.

17. The method of claim 16, wherein the determining whether the preset initialization event has occurred comprises determining whether a vehicle power off signal is received.

18. The method of claim 9, wherein the determining the new output limit value comprises calculating the new output limit value such that the difference between the monitored output value of the battery and the preset initial output limit value becomes zero.

19. An apparatus of a vehicle, the apparatus comprising:
a battery of the vehicle;
a processor; and
a memory storing at least one instruction that is configured, when executed by the processor communicating with the memory, to cause the apparatus to:
adjust, based on a monitored output value of the battery exceeding an allowable range of output values of the battery for a period of time longer than a threshold time, an initial output limit value of the battery wherein the adjusted output limit value is less than the initial output limit value, and
control, based on the adjusted output limit value, a peak output of the battery, and
perform, based on the peak output of battery being controlled by the adjusted output limit value, at least one operation of the vehicle.

20. The apparatus of claim 19, wherein the at least one instruction is configured, when executed by the processor communicating with the memory, to cause the apparatus to reset, based on receiving a reset signal of the vehicle, the adjusted output limit value back to the initial output limit value.
